(19) United States
(12) Patent Application Publication
(10) Pub. No.: US 2021/0188699 A1
(43) Pub. Date: Jun. 24, 2021

(54) METAL ANTICORROSIVE COATING, PREPARATION METHOD THEREFOR, AND USE THEREFOR

(71) Applicant: Zhejiang University, Hangzhou (CN)

(72) Inventors: Dongming Yan, Hangzhou (CN); Yi Liu, Hangzhou (CN); Zhihao Huang, Hangzhou (CN)

(21) Appl. No.: 17/054,177

(22) PCT Filed: Nov. 5, 2019
(86) PCT No.: PCT/CN2019/086505

§ 371 Date: Nov. 10, 2020

(30) Foreign Application Priority Data
May 12, 2018 (CN) 201810451926.0

(51) Int. Cl. C03C 8/14; C23D 5/04

(52) U.S. Cl. CPC C03C 8/14; C03C 2204/00; C03C 2207/04; C23D 5/04

(57) ABSTRACT

The invention discloses a metal anticorrosive coating. The coating is an inorganic coating used for metal anticorrosion. This coating has a double-layer structure, including an outer enamel coating and an inner base oxide coating. Meanwhile, the content of the base metal oxide decreases from the inner layer to the outer layer, which causes the thermal expansion coefficient of the coating to increase from the inner layer to the outer layer, ensures that the overall thermal expansion coefficient of the coating is coordinate with various base metals. The composition of the outer layer enamel coating includes: by weight, 1-40 parts of silicon, 1-30 parts of sodium, 1-20 parts of potassium, 2-20 parts of calcium, 0.5-15 parts of fluorine, 0.3-10 parts of cobalt, 0.2-10 parts of nickel, 1-18 parts of boron, 0.5-10 parts of phosphorus, 0.1-8 parts of magnesium, and the rest is oxygen; the composition of the base oxide coating of the inner layer includes the base metal and oxygen. A preparation process of a double-layer dense metal anticorrosive coating formed by low-temperature sintering is also disclosed, including the following steps: 1) grinding; 2) preparation of mixture; 3) grinding; 4) high temperature reaction; 5) grinding; 6) coating; 7) sintering. The coating of the invention has the advantages of improving the corrosion resistance by more than 14 times, has a high ductility which can be coordinated with the reinforcing steel bar in tensile deformation, has a thermal expansion coefficient gradient which can be applied to different metals and different types of the same metal.

### CROSS REFERENCE TO RELATED APPLICATION

This application is a national stage application of International application number PCT/CN2019/086505, filed May 11, 2019, titled “METAL ANTICORROSIVE COATING, PREPARATION METHOD THEREFOR, AND USE THEREFOR,” which claims the priority benefit of Chinese Patent Application No. 201810451926.0, filed on May 12, 2018, which is hereby incorporated by reference in its entirety.

### TECHNICAL FIELD

The present invention relates to the field of metal anti-corrosion materials, in particular to metal anticorrosive coating, preparation method therefor, and use therefor.

### BACKGROUND

In the 21st century, China has entered an era of great coastal economic development, and a large number of harbor terminals, cross-sea bridges, tunnels, etc. will use reinforced concrete structures. While the corrosion of steel bars is a major factor affecting the durability of reinforced concrete. Not only at the seaside, steel poles in saline-alkali areas, pipe piles and bridge piers in humid environments will also be affected by corrosion. Therefore, for the reinforced concrete building structure in harsh environments (such as acid rain, marine environment, deicing salt, high and low temperature environment, humid environment, etc.), the effective anti-corrosion measures must be taken to ensure that the building reaches the designed life.

Inorganic coatings include phosphate coatings, silicate coatings, enamel coatings, etc. Among them, the enamel coating must undergo a sintering process during the manufacturing process, and the sintering will produce two inherent disadvantages: 1) The thermal expansion coefficients of the coating and the base metal cannot be coordinated with each other, making the coating and the base metal deformation inconsistent, which in turn causes cracks in the coating; 2) Evaporation of water vapor during sintering produces some through holes. The base metals refer to the metals which require the corrosion protections, for example, steel bars, aluminum plates, copper plates, etc. The coordination means that the thermal expansion coefficient of the coating is equal to or appropriately greater than that of the base metal, and changes with the change of the thermal expansion coefficient of the base metal, so as to ensure that the coating does not generate cracks at high temperature and improve the corrosion resistance of the coating.

In the prior art, some technologies are only employed to solve the thermal expansion coefficient problems, and the other technologies are only employed to solve the through hole problems. So far, the thermal expansion and the through holeproblems have not been solved well, furthermore, no technical solution, which can solve these two problems simultaneously, was reported. In addition, there is no relevant research report on the universality of metal anti-corrosion coatings. The universality problem refers to how to make a metal anti-corrosion coating adapt to the thermal expansion coefficients of different types of metals. It is well known that the thermal expansion coefficients of different metals are very different. For example, the thermal expansion coefficient of magnesium is 24×10′/° C., while the thermal expansion coefficient of iron is only 12×10′/° C. The present metal anti-corrosion coatings cannot be applied to various metals with greatly different thermal expansion coefficients.

Chinese patent CN106116438A discloses a magnesium phosphate-based reinforcing steel protective coating material and its preparation method. The coating is a cementitious material that forms the chemical bonds through the acid-base neutralization reaction to produce strength. But the cost is high and the corrosion resistance is not superior. Chinese patent CN105131660B discloses a steel anti-corrosion coating and its coating method, in which the fiber is introduced so that the anti-corrosion coating absorbs energy during fracture to achieve the purpose of delaying cracking. Chinese patent CN105238105B discloses a tough coating for anti-corrosion of steel bars and its coating method, in which the coating has outstanding corrosion resistance, extremely high toughness and high durability by adding feldspar powder, clay, fluorite and other raw materials. Chinese patent CN105819691A discloses a small pore size inorganic coating for anticorrosion of steel bars and its coating method, in which the internal pore size of the anticorrosion coating is decreased to improve the corrosion resistance. Chinese patent CN105585883B discloses a low-temperature sintered coating for anticorrosion of steel bars and its coating method, in which the coating sintered at a temperature of 400-550 degrees. Chinese patent CN 105670366 discloses a low-porosity coating for anti-corrosion of steel bars and a coating method thereof, in which the through-porosity of the coating is reduced, thereby improving the anti-corrosion performance. In 2014, Dongfang Yang mentioned a kind of corrosion-resistant glass coating in the master thesis “Reinforcement Surface Corrosion Prevention and Strengthening Reinforcement/Cement Bonding Glass Coating”, which has a good corrosion resistance and adhesion. However, the above patents mainly focus on the changes of the coating components, and do not optimize the structure of the coatings, while the coating structure plays a decisive role in the corrosion resistance of the material. Therefore, the above patents are not revolutionary update of corrosion resistance.

U.S. Pat. Nos. 7,901,769B2 and 8,679,389B2 disclose an anti-corrosion glass coating for steel enamel, the coefficient of thermal expansion ranges from 12.5×10⁻⁶/° C.-13.5×10⁻⁶/° C. (12.5 ppm/° C.-13.5 ppm/° C.). However, the thermal expansion coefficient span of this coating is too small, and the span range is only 1.0×10⁻⁶/° C., which cannot fundamentally solve the adverse effect of the different thermal expansion coefficients between the reinforcement and the coating on the corrosion resistance. In the market, rebars vary in manufacturing process, batch, and sintering temperature, therefore the thermal expansion coefficients of the rebarschange between 11.5×10′/° C.-14.5×10′/° C. The range of thermal expansion coefficient of coating is too small to be suitable for steel bars with a thermal expansion coefficient greater than 13.5×10′/° C., so it is not universal and cannot be used for different types of steel bars. If the thermal expansion coefficient of the coating is smaller than the thermal expansion coefficient of the steel bar, the coating would deform inconsistently with the steel bar during the sintering process (the deformation of the steel bar is greater than that of the coating), which could cause small cracks in the coating. Usually, for anti-corrosion coating, any small cracks in the coating would cause a decline in corrosion resistance, and even accelerate the progress of corrosion, so the thermal expansion coefficient of the coating must not be smaller than that of the base metal, otherwise it would cause cracks in the coating. Meanwhile, the thermal expansion coefficient of the coating cannot be much bigger than that of the base metal. When the thermal expansion coefficient of the coating is too large, a large in-plane pressure stress would occur in the coating, thus the coating would become unstable and peel off. The peeling of the coating also inevitably leads to a rapid decline in the corrosion resistance. Taking the above-mentioned United States as the examples, the thermal expansion coefficients of the base steel bars are 11.5×10′/° C.-12.5×10⁻⁶/° C. and 13.5×10⁻⁶/° C.-14.5×10⁻⁶/° C. While the thermal expansion coefficients of the coatings in the US patents are only 12.5×10⁻⁶/° C.-13.5×10′/° C., the coating is not in harmony with the steel bar. As a result, the coating would crack.

Therefore, the thermal expansion coefficients of the coating and the base metal should be coordinated. When the thermal expansion coefficient of the coating is equal to or appropriately greater than that of the base metal, the thermal expansion coefficient of coating would change with the change of thermal expansion coefficient of the base metal, which can ensure that the coating could not produce any small cracks at high temperatures. Then the corrosion resistance of the coating could be improved.

In summary, there are two problems in the prior art that have not been solved for metal anti-corrosion coatings. The first problem is that the thermal expansion coefficients of different metals are very different. For example, the thermal expansion coefficient of magnesium is 24×10⁻⁶/° C., while the thermal expansion coefficient of iron is only 12×10′/° C. This results in that the thermal expansion coefficient of the same metal anti-corrosion coating cannot be coordinated with these of magnesium and iron. Therefore the same metal anti-corrosion coating cannot be used to adapt to the corrosion of different base metals, which means that the prior art coatings do not have common adaptability. The second problem is that the same metal shows some different thermal expansion coefficients due to different manufacturing processes and other reasons. For example, the thermal expansion coefficients of steel bars usually vary between 11.5×10′/° C.-14.5×10⁻⁶/° C. Taking US patents U.S. Pat. No. 7,901,769B2 and U.S. Pat. No. 8,679,389B2 as examples, the thermal expansion coefficient range of the coating is only 12.5×10′/° C.-13.5×10⁻⁶/° C., the span of the thermal expansion coefficient of the coating is too small to cover the thermal expansion coefficient range of the steel bars. Thus the coatings cannot be applied to all types of steel bars. Therefore, the prior art cannot provide a universal anticorrosive coating that can be applied to various metals and different types of metals and environments.

### DESCRIPTION OF THE INVENTION

In order to overcome the shortcomings and deficiencies of the existing anti-corrosion coating technologies, the present invention provides a metal anticorrosive coating with a double-layer structure and excellent corrosion resistance. The coating has a large thermal expansion coefficient range, and thermal expansion coefficient would change according to the change of the base metal, which is universal and can be applied to various metals and different types of metals. Furthermore, the metal anticorrosive coating prepared by the present invention has a dense structure with no through holes and a closed pore rate of less than 5%, which further improves the corrosion resistance of the coating. A small number of closed holes would make the coating have a certain ability to expand and deform. The corrosion resistance of the existing metal anti-corrosion coating is generally not more than 10 times that of the metal without the coating, which is due to the problem that affects the metal anti-corrosion coating is not fundamentally solved. The present invention essentially solves this problem, thereby greatly improving the corrosion resistance of the coating. The corrosion resistance of the metal anti-corrosion coating of the invention is 14 times higher than that of the metal without the coating. It can be used in more severe corrosive environments.

The present invention is achieved through the following technical solutions:

A metal anti-corrosion coating is a double-layer structure coating, which is composed of an enamel coating and a base oxide coating;

In the double-layer structure, the enamel coating is the outer layer, and the base oxide coating is the inner layer. The composition of the enamel coating includes the following components by weight: 1-40 parts of silicon, 1-30 parts of sodium, 1-20 parts of potassium, 2-20 parts of calcium, 0.5-15 parts of fluorine, 0.3-10 parts of cobalt, 0.2-10 parts of nickel, 1-18 parts of boron, 0.5-10 parts of phosphorus, 0.1-8 parts of magnesium, the rest is oxygen. The composition of the base oxide coating includes base metal and oxygen;

In the two-layer structure coating, there is a base metal oxide with a reduced concentration gradient from the inner layer to the outer layer.

The base metal refers to a metal that needs corrosion protection, for example, steel bars, aluminum plates, copper plates, etc., the base oxide coating is close to the base metal (see FIG. 2).

Further, the thermal expansion coefficient of the double-layer structure coating is consistent with the thermal expansion coefficient of the base metal.

The coordination means that the thermal expansion coefficient of the double-layer structure coating is equal to or appropriately greater than that of the base metal, and changes with the thermal expansion coefficient of the base metal to ensure that the coating does not generate cracks at high temperatures, to improve the corrosion resistance of the coating.

As we all know, when the thermal expansion coefficient of the coating is smaller than that of the base metal, small cracks would occur in the coating, resulting in a rapid decline in the corrosion resistance of the coating. While the thermal expansion coefficient of the coating is too big, in-plane compressive stress would be generated in the coating, which would lead to the instability and flaking of the coating, and reduce the corrosion resistance of the coating. Therefore, the coating in the present invention has two advantages in thermal expansion coefficient: first, the span of the thermal expansion coefficient of the coating in the present invention is large. For example, when the base metal is iron or steel, the thermal expansion coefficient of the coating is 10×10⁻⁶/° C.-16×10⁻⁶/° C., the thermal expansion coefficient of iron or steel is 11.5×10⁻⁶/° C.-14.5×10⁻⁶/° C.

The thermal expansion coefficient of the coating of the present invention could include all types of iron or steel, and even if the thermal expansion coefficient of a certain batch of steel bars varies, it could be well adapted. Second, the thermal expansion coefficient of the coating in the present invention would change with the change of the base metal to adapt to the thermal expansion coefficient of the base metal. When the base metal is iron, copper, magnesium, or aluminum, the base oxide coating in the double-layer coating contains the base metal oxide, so that the thermal expansion coefficient of the overall coating could change with the change of the base metal to adapt to different metals.

Because the gradient of the base metal oxide concentration decreases from the base oxide coating to the enamel coating, the double-layer coating has a thermal expansion coefficient that increases from the base oxide coating to the enamel coating. In addition, the thermal expansion coefficient gradient of coating can effectively promote the migration of the metal element. The base metal element would react with the oxygen element to form the corresponding base metal oxide, thereby forming the base oxide coating. In this way, the adhesion property of the double-layer structure coating to the base metal can be ensured, and the thermal expansion coefficient of the double-layer structure coating can change with the change of the base metal. The specific element composition (1-40 parts silicon, 1-30 parts sodium, 1-20 parts potassium, 2-20 parts calcium, 0.5-15 parts fluorine, 1-18 parts boron, 0.3-10 parts cobalt, 0.2-10 parts nickel, 0.5-10 parts of phosphorus, 0.1-8 parts of magnesium, and the rest of oxygen) of the double-layer structure coating is first to form the skeleton and foundation of the entire coating, at the same time the thermal expansion coefficient of the double-layer structure coating can be adjusted, so that the span of the thermal expansion coefficient can be guaranteed to be around 6×10⁻⁶/° C. (If the base metal is iron, the thermal expansion coefficient of the coating is in the range of 10×10⁻⁶/° C.-16×10⁻⁶/° C., then the span of the thermal expansion coefficient of the coating is 6×10′/° C.; When the metal is copper, the thermal expansion coefficient range of the coating is 13×10′/° C.-20×10⁻⁶/° C., and the span of the thermal expansion coefficient of the coating is 7×10⁻⁶/° C.). Furthermore, the elements such as silicon, sodium, potassium, calcium, fluorine, boron, cobalt, nickel, phosphorus, magnesium, and oxygen can also effectively reduce the melting point of the reaction system, increase the diffusion rate of substances, and promote the contact and reaction among the multiple raw materials interfaces. And these elements can react with the base metal oxide in the base oxide coating to form complex oxides. These oxides have strong chemical bonds, which effectively promote the migration of metal elements, and increase the bonding strength between the enamel coating and the base oxide coating. At the same time, because of the presence of the enamel coating and the base oxide coating, the thermal expansion coefficient of the double-layer coating can change accordingly with the change of the base metal. Besides, the above elements consume part of the oxygen element, which results in the concentration of the base metal oxide of the overall coating showing a gradient decrease from the base oxide coating to the enamel coating. As a result, the thermal expansion coefficient of the coating would gradiently increase from the base oxide coating to the enamel coating, thereby solving the universality of the metal anti-corrosion coating.

Further, the double-layer structure coating is a dense structure which has no through holes and a closed pore rate of less than 5%. No through-hole means that there is no through-hole from the surface of the enamel coating to the surface of the base metal, and the closed-pore ratio is less than 5% means that the ratio of the cross-sectional area of closed-pore (non-through-hole) to the total cross-sectional area of the coating is not greater 5%. It is well known that sintering is a necessary step in the preparation of enamel coatings. In the sintering process, due to the evaporation of water, the high temperature reaction of impurities in metal products to create gases and other factors would cause through holes in the coating. The double-layer structure coating of the present invention contains silicon, sodium, potassium, calcium, fluorine, cobalt, nickel, boron, phosphorus, magnesium, and oxygen elements (by weight, silicon 1-40 parts, sodium 1-30 Parts, potassium 1-20 parts, calcium 2-20 parts, fluorine 0.5-15 parts, cobalt 0.3-10 parts, nickel 0.2-10 parts, boron 1-18 parts, phosphorus 0.5-10 parts, magnesium 0.1-8 parts, the rest is oxygen), enables the coating to have a double-layer thermal expansion coefficient gradient structure, so that no through holes appear, and at the same time, the closed pore ratio of the coating is lower than 5%. Two points of no through holes and low closed pore ratio can make the corrosion resistance of the coating structure further improved. A few closed pores in the coating would make the coating have a certain ability to expand and deform.

Further, the content of the base metal in the base oxide coating is 40-85 parts, and the rest is oxygen.

Further, the compositions of the enamel coating include 2-30 parts of silicon, preferably 3-15 parts; 2-20 parts of sodium, preferably 7-16 parts; 2-15 parts of potassium, preferably 3-10 parts; 4-16 parts of calcium, preferably 5-11 parts; 2-10 parts of fluorine, preferably 3-7 parts; 0.5-7 parts of cobalt, preferably 1-4 parts; 0.3-8 parts of nickel, preferably 0.5-4 parts; boron 2-10 parts, preferably 2.5-8 parts; phosphorus 0.8-6 parts, preferably 1-4 parts; magnesium 0.2-5 parts, preferably 0.5-2 parts; the rest is oxygen.

The base metal is selected from iron, steel, copper, copper alloy, aluminum, aluminum alloy, magnesium, magnesium alloy. When the base metal is iron or steel, the thermal expansion coefficient of the double-layer structure coating is 10×10⁻⁶/° C.-16×10⁻⁶/° C. When the base metal is copper or copper alloy, the thermal expansion coefficient of the double-layer structure coating is 13×10⁻⁶/° C.-20×10⁻⁶/° C. When the base metal is aluminum or aluminum alloy, the thermal expansion coefficient of the double-layer structure coating is 20×10⁻⁶/° C.-26×10⁻⁶/° C.; When the base metal is magnesium or magnesium alloy, the thermal expansion coefficient of the double-layer structure coating is 23×10⁻⁶/° C.-29×10⁻⁶/° C.

Further, the elements of silicon, sodium, potassium, calcium, fluorine, cobalt, nickel, boron, phosphorus, magnesium, and oxygen are determined by energy dispersive spectrometry (EDS), and the specific method is: the EDS test is operated on an energy spectrometer. First, the surface of the sample is ground and polished, and the gold nanoparticles are sprayed on the surface to make a gold film which is conductive, and then the sample is attached to the conductive tape. The acceleration voltage value is adjusted to 10-40 kV, the dead time is 15-45%, and the measurement time is fixed to 50-400 s. The sample is put into the sample cavity, the parameters are set and the vacuum makes the focus clear, the area is selected that needs element analysis and the position is maintained, the point scan, area scan, line scan for element analysis are applied.

Further, the sources of the enamel coating compositions come from enamel powder, thermal expansion regulator, flux, and binder. The content of the enamel powder is 40-90 parts, preferably 60-75 parts; the content of the thermal expansion regulator is 5-40 parts, preferably 10-25 parts; the content of the flux is 1-20 parts, preferably 5-12 parts; the content of the binder is 0.5-12 parts, preferably 2-6 parts, the content is by weight.

In the enamel coating, 40-90 parts of the enamel powder are the basis of the whole enamel coating. The addition of thermal expansion regulators, binders, and fluxes allows the enamel coating to bond tightly with the base oxide coating during the sintering process, forming a double-layer thermal expansion coefficient gradient structure, and the overall structure of the coating is dense. Further, the addition of 5-40 parts of thermal expansion regulator, 1-20 parts of flux, and 0.5-12 parts of binder can effectively adjust the thermal expansion coefficients of the enamel powder, binder, and flux. Therefore the enamel coating has a thermal expansion coefficient gradient from the inside to the outside to achieve the purpose of coordinated uniform expansion and contraction which can effectively avoid the expansion or contraction cracking and shedding due to uneven stress during the heating and cooling of the enamel coating. Because of the gradient of the thermal expansion coefficient from inside to outside, the coating could not expand or shrink due to uneven internal and external stresses. Meanwhile, the addition of the thermal expansion regulator ensures the span of the thermal expansion coefficient of the double-layer structure coating to be around 6×10⁻⁶/° C. (If the base metal is iron, the thermal expansion coefficient of the coating is 10×10⁻⁶/° C.-16×10⁻⁶/° C., then the span of the thermal expansion coefficient of the coating is 6×10⁻⁶/° C.; when the base metal is copper, the thermal expansion coefficient of the coating is 13×10⁻⁶/° C.-20×10/° C., and the span of the thermal expansion coefficient of the coating is 7×10⁻⁶/° C.). Meanwhile, the addition of 5-40 parts of thermal expansion regulator, 1-20 parts of flux, and 0.5-12 parts of binder can effectively reduce the melting point of the reaction system, increase the diffusion rate of substances, and promote the contact and reaction among various raw materials interfaces. So that the sintering temperature of the enamel coating is reduced and the adhesion to the base oxide layer is increased. Further, the enamel coating and the base oxide coating can react during the sintering process to form the stronger chemical bonds, which effectively promote the migration of metal elements, thereby making the enamel coating and the base oxide coating bond is tight and the adhesion of the base oxide coating to the base metal is tight. The enamel powder, thermal expansion regulator, flux, and binder of the present invention as a synergistic body to produce an enamel coating and a base oxide coating. The presence of these two layers makes the thermal expansion coefficient of the two-layer coating change correspondingly with the change of the base metal. Meanwhile, the binder consumes part of the base metal oxide, which results in the gradient decrease of the base metal oxide concentration of the whole coating from the base oxide coating to the enamel coating. While it also results in a gradient increase of the thermal expansion coefficient of the coating from the base oxide coating to the enamel coating. Therefore it can solve the problem of universality of coating.

Further, the element content of the enamel powder is: 1-40 parts of silicon, preferably 2-15 parts; 1-20 parts of sodium, preferably 3-12 parts; 1-23 parts of potassium, preferably 4-13 parts; 1-18 parts of calcium, preferably 3-11 parts; 0-10 parts of boron, preferably 0-5 parts; 0.8-10 parts of phosphorus, preferably 1-5 parts; Preferably, the particle size of the enamel powder is 1000-2000 mesh, preferably 1200-1800 mesh. This enamel powder does not contain toxic elements such as mercury and lead, and has a low melting point, which can greatly reduce the sintering temperature of the coating, thereby reducing the performance degradation of metals caused by high temperature.

Further, in the enamel powder, silicon oxides content is 3 to 39 parts, sodium oxides content is 3 to 28 parts, potassium oxides content is 1 to 25 parts, boron oxides content is 0 to 15 parts, and phosphorus oxides content is 0.5 to 10 parts, the content is based on weight.

Further, the silicon oxides are selected from one or more of silicon oxide, silicon dioxide, and silicon peroxide.

Further, the sodium oxides are selected from one or more of sodium oxide, sodium peroxide, and sodium hydroxide.

Further, the potassium oxides are selected from one or more of potassium oxide, potassium carbonate, and potassium hydroxide.

Further, the phosphorus oxides are selected from one or more of phosphorus trioxide, phosphorus pentoxide.

Further, the thermal expansion regulators are selected from one or more of sodium silicate, potassium silicate, calcium silicate, magnesium silicate, sodium tetraborate, potassium tetraborate, calcium borate, barium borate, lithium borate.

Further, the fluxs are selected from one or more of sodium carbonate, potassium carbonate, magnesium carbonate, strontium carbonate, lithium carbonate, calcium carbonate, barium carbonate, calcium fluoride, magnesium fluoride, and potassium fluoride.

Further, the binders are selected from one or more of cobalt monoxide, cobalt trioxide, nickel monoxide, and nickel trioxide.

Further, the thickness of the double-layer structure coating is not less than 40 μm; preferably, the thickness of the double-layer structure coating is not less than 50 μm.

Further, the thickness of the enamel coating is 40-320 μm, and the thickness of the base oxide coating is 10-50 μm. If the thickness is less than 40 μm, the corrosion resistance of the coating would be significantly weakened. If the thickness exceeds 400 μm, then the internal stress of the coating would be too large resulting in the formation of cracks in the coating, and also reduce the corrosion resistance of the coating.

Further, when the double-layer structure coating is applied to anti-corrosion of steel bars, the base metal is steel, and the coefficient of thermal expansion of the double-layer structure coating ranges from 10×10⁻⁶/° C. to 16×10⁻⁶/° C., the ultimate tensile strain of the two-layer structure coating is 1200-2300 micro-strains (με), preferably 1400-2200 micro-strains (μE). This is because the double-layer structure coating of the present invention is composed of silicon, sodium, potassium, calcium, fluorine, cobalt, nickel, boron, phosphorus, magnesium, and oxygen elements in a specific ratio (by weight, silicon 1-40 parts, Sodium 1-30 parts, potassium 1-20 parts, calcium 2-20 parts, fluorine 0.5-15 parts, cobalt 0.3-10 parts, nickel 0.2-10 parts, boron 1-18 parts, phosphorus 0.5-10 parts, magnesium 0.1-8 copies, the rest is oxygen). These elements would form a double-layer structure coating during the sintering process. Because of the double-layer structure, the coating can expand the range of ultimate tensile strain and adapt to the reinforcement. Meanwhile, a small number of closed pores (less than 5% closed pores) in the coating can make the coating have better ductility, and also increase the ultimate tensile strain of the coating. It can be known from the Chinese patent CN105238105B that the maximum strain value range specified in the design of building reinforcement is: 1286-2175 micro-strain (μE), in which the maximum strain value of HPB300 grade steel bars is the smallest, and the HRB500 grade steel bars is the largest. As we all know, the design strength value of a building tends to be higher than the actual strength value of the building, which is the so-called design surplus value, therefore the strain value of the building steel bar in actual use often does not reach the maximum value of the design. The limit tensile strain value of the present invention is 1200^{˜}2300 microstrain (με), including the range of the maximum strain value of all steel bars for construction. In theory, it can be considered that the coating can deform cooperatively with the steel bar, which means that the coating would not crack under working conditions and have excellent corrosion resistance.

Further, when the double-layer structure coating is applied to metal corrosion protection, the corrosion resistance of the metal is increased more than 14 times. The corrosion resistance of the existing metal anti-corrosion coating is generally not more than 10 times that of the metal without coating, because the problem that affects the metal anti-corrosion coating is not fundamentally solved. The present invention essentially solves this problem, thereby greatly improving the corrosion resistance of the coating. The corrosion resistance of the metal anti-corrosion coating of the invention is 14 times higher than that of the metal without a coating. It can be used in more severe corrosive environments.

The second object of the present invention is to provide a method for preparing a metal anticorrosive coating and a metal product with a metal anticorrosive coating, including the following steps:

1) The first grinding: weight the enamel powder, thermal expansion regulator, flux, binder. The content of the enamel powder is 40-90 parts, preferably 60-75 parts; the content of the thermal expansion regulator is 5-40 parts, preferably 10-25 parts; the flux content is 1-20 parts, preferably 5-12 parts; the binder content is 0.5-12 parts, preferably 2-6 parts. The stated content is by weight. And grind into powder.

2) Preparation of the mixture: mixing the above four raw materials with water to obtain a mixture;

3) Second grinding: grind the mixture obtained in step 2) into powder after drying;

4) High-temperature reaction: the mixture obtained in step 3) is reacted in a high-temperature furnace at 520 to 720° C. for 10 to 20 minutes;

5) Third grinding: grind the mixture after high temperature reaction to obtain coating powder;

6) Coating: coating the powder obtained in step 5) on the base metal;

7) Sintering: the powder-coated base metal obtained in step 6) is sintered at high temperature to obtain a metal anticorrosive coating and a metal product with a metal anticorrosive coating.

Further, the coating method of step 6) may use an electrostatic spray method, in which the electrostatic voltage is 30-90 kV, the current is 20-80 μA, the powder output is 200-700 g per minute, and the spray distance is 10-30 cm.

Further, the sintering parameters of step 7) are: the temperature is 500 to 620° C., the sintering time is 10 to 20 minutes, and the heating rate is 5 to 15° C. per minute.

Further, the base metal is selected from iron, steel, copper, copper alloy, aluminum, aluminum alloy, magnesium, magnesium alloy.

Further, the content of the base metal in the base oxide coating is 40-85 parts, and the rest is oxygen.

Further, the enamel coating is composed of added enamel powder, thermal expansion regulator, flux, and binder. The content of the enamel powder is 40-90 parts, the content of the thermal expansion regulator is 5-40 parts, the content of flux is 1-20 parts, the content of binder is 0.5-12 parts. Corresponding element content: 2-30 parts of silicon, 2-20 parts of sodium, 2-15 parts of potassium, 4-16 parts of calcium, 2-10 parts of fluorine, 0.5-7 parts of cobalt, 0.3-8 parts of nickel, 2-10 parts of boron, 0.8-6 parts of phosphorus, 0.2-5 parts of magnesium, the rest is oxygen. The content is by weight.

Further, the enamel powder is composed of added siliconoxides, sodiumoxides, potassiumoxides, boron oxide, phosphorusoxides, the content of siliconoxides is 3-39 parts, the content of sodiumoxides is 3-28 parts, the content of potassiumoxides is 1-25 parts, the content of boron oxide is 0-15 parts, the content of phosphorusoxides is 0.5-10 parts. Corresponding element content: 1-40 parts of silicon, 1-20 parts of sodium, 1-23 parts of potassium, 1-18 parts of calcium, 0-10 parts of boron, 0.8-10 parts of phosphorus. The content is based on weight. Preferably, the particle size of the enamel powder is 1000-2000 mesh, preferably 1200-1800 mesh.

Further, the siliconoxidesare selected from one or more of silicon oxide, silicon dioxide, and silicon peroxide.

Further, the sodiumoxides are selected from one or more of sodium oxide, sodium peroxide, and sodium hydroxide.

Further, the potassiumoxides are selected from one or more of potassium oxide, potassium carbonate, and potassium hydroxide.

Further, the phosphorusoxidesare selected from one or more of phosphorus trioxide and phosphorus pentoxide.

Further, the thermal expansion regulators are selected from one or more of sodium silicate, potassium silicate, calcium silicate, magnesium silicate, sodium tetraborate, potassium tetraborate, calcium borate, barium borate, and lithium borate.

Further, the fluxs are selected from one or more of sodium carbonate, potassium carbonate, magnesium carbonate, strontium carbonate, lithium carbonate, calcium carbonate, barium carbonate, calcium fluoride, magnesium fluoride, and potassium fluoride.

Further, the binders are selected from one or more of cobalt monoxide, cobalt trioxide, nickel monoxide, and nickel trioxide.

Further, the thickness of the double-layer structure coating is not less than 40 μm; preferably, the thickness of the double-layer structure coating is not less than 50 μm.

Further, the thickness of the enamel coating is 40-320 μm, and the thickness of the base oxide coating is 10-50 μm.

The third object of the present invention is to provide a metal product including any metal anticorrosive coating as described above.

Further, the metal product is selected from iron products, steel products, steel products, copper products, and aluminum products. The metal products may be in various shapes, for example, the shapes of iron products include but are not limited to plate-shaped, rod-shaped, rod-shaped, and the like.

The fourth object of the present invention is to provide the metal anti-corrosion coating and the use of the metal products in anti-corrosion, which can be applied in civil buildings, pipelines, underground pipe corridors, marine oil production platforms, saline-alkali infrastructure, new energy power generation and many other fields.

Compared with the prior art, the present invention has the following beneficial effects:

(1) The present invention not only focuses on improving the coating performance from the optimization of the material itself, but also optimizes the performance by introducing a double-layer coating structure. The invention not only enables the coating to adapt to the thermal expansion coefficients of different metals from the perspective of the thermal expansion coefficient of the coating, but also makes the coating dense and non-through-hole from the perspective of the coating structure, and the closed pore rate is less than 5%. These two aspects make the coating change from quantity to quality, the corrosion resistance is 5 times of CN105131660B patent, 2.5 times of CN105238105B patent, 2 times of CN105585883B patent, 1.5 times of CN105670366B patent, 1.4 times of CN105819691A patent, and 14 times of ordinary bare steel. The corrosion resistance is extremely superior. (2) The coating of the invention has a double-layer thermal expansion coefficient gradient structure, and the thermal expansion coefficient increases with the decrease of the metal oxide concentration, thereby reducing the internal stress in the coating, making the coating tightly combined with the base metal, and not easy to crack, which can improve corrosion resistance of the coating. (3) In the present invention, the thermal expansion coefficient can be coordinated with various base metals. For iron, steel, copper, copper alloy, aluminum, aluminum alloy, magnesium, magnesium alloy and other metals, the base metal oxide penetrates into the coating and thus it can adjust the thermal expansion coefficient of the coating. This means that the coating is universal and can be applied to various kinds of metals. (4) In the present invention, for the same metal, the coating has a large thermal expansion coefficient span, and can be applied to the same metal in different types and different environments. (5) In the present invention, the problem of through holes in the sintering of the enamel coating is solved. The coating of the present invention has no through holes and the closed pore rate is less than 5%. Meanwhile, cracks caused by differences in thermal expansion coefficients are also solved. No previous patents have solved both problems. (6) The required sintering temperature of the coating of the present invention is between 500-620° C. When metal is sintered in this temperature range, the yield strength only decreases by 2%, the ultimate strength only decreases by 1.4%, and the elongation only decreases by 3%. (7) The invention has a good wear resistance. In practical applications, metal would inevitably encounter friction and contact with various objects improve. The wear resistance of the coating is improved, which can ensure the integrity of the coating to a certain extent.

### BRIEF DESCRIPTION OF THE DRAWINGS

FIG. 1a shows a picture of electrostatic sprayed round steel, FIG. 1b shows a picture of electrostatic sprayed rebar.

FIG. 2 shows a partial electron micrograph of Embodiment 1 (the scale is 250 μm).

FIG. 3 shows a partial electron micrograph of Embodiment 1 (scale is 100 μm).

### DETAILED DESCRIPTION OF THE PREFERRED EMBODIMENTS

The following examples are only used to illustrate the present invention and not limit the scope of the present invention. In addition, it should be understood that, after reading the content of the present invention, those skilled in the art can make various changes or modifications to the present invention, and these equivalent forms also fall within the scope defined by the appended claims of the present invention.

### Embodiment 1: Preparation of Double-Layer Thermal Expansion Coefficient Gradient Structure Coating

1) The first grinding: weight the enamel powder, thermal expansion regulator, flux, binder. The content of the enamel powder is 40-90 parts, preferably 60-75 parts; the content of the thermal expansion regulator is 5-40 parts, preferably 10-25 parts; the flux content is 1-20 parts, preferably 5-12 parts; the binder content is 0.5-12 parts, preferably 2-6 parts. The stated content is by weight. And grind into powder.

2) Preparation of the mixture: mixing the above four raw materials with water to obtain a mixture;

3) Second grinding: grind the mixture obtained in step 2) into powder after drying;

4) High-temperature reaction: the mixture obtained in step 3) is reacted in a high-temperature furnace at 600° C. for 15 minutes;

5) Third grinding: grind the mixture after high temperature reaction to obtain coating powder;

6) Coating: coating the powder obtained in step 5) on the base metal using an electrostatic spray method, in which the electrostatic voltage is 80 kV, the current is 20 μA, the powder output is 500 g per minute, and the spray distance is 15 cm.

7) Sintering: the powder-coated base metal obtained in step 6) is sintered at 530° C. The sintering time is 15 minutes, and the heating rate is 7.5° C. per minute. At the end, the temperature is naturally cold to room temperature to obtain a metal anticorrosive coating and metal products with a metal anticorrosive coating.

The specific steps of embodiments 1-8 and comparison embodiments 1-3 are as in embodiment 1, and the specific ratio (weight ratio) is shown in Table 1.

TABLE 1
Specific composition ratio (weight ratio) and production process parameter
settings of embodiments 1-8 and comparison embodiments 1-3.

| | | Embodi- | Embodi- | Embodi- | Embodi- | Embodi- | Embodi- |
|---|---|---|---|---|---|---|---|
| | | ment 1 | ment 2 | ment 3 | ment 4 | ment 5 | ment 6 |
| | | Base metal | | | | | |
| | | | | | | | Copper or |
| | | Iron or | Iron or | Iron or | Iron or | Iron or | copper |
| | | steel | steel | steel | steel | steel | alloy |
| Enamel powder | Total | 67 | 40 | 90 | 60 | 75 | 67 |
| Thermal expansion | Sodium silicate | 12 | | 3 | 3 | | 12 |
| coefficient regulator | Potassium silicate | | 12 | 1 | 3 | 10 | |
| | Calcium silicate | | 8 | 1 | 4 | | |
| | Sodium tetraborate | | 10 | | | | |
| | Potassium tetraborate | 5 | 10 | | | | 5 |
| | Calcium borate | | | | | 8 | |
| Flux | Sodium carbonate | 5 | | | 5 | | 5 |
| | Potassium carbonate | | 3 | | 5 | | |
| | Magnesium carbonate | | | 0.5 | 10 | | |
| | Calcium fluoride | 5 | | 0.5 | | 2 | 5 |
| | Potassium fluoride | | 5 | | | | |
| | Magnesium fluoride | 1 | | | | 3 | 1 |
| Binder | Cobalt monoxide | 3 | 3 | 2 | 3 | | 3 |
| | Cobalt trioxide | | 3 | | 3 | 1 | |
| | Nickel oxide | 2 | 3 | | 2 | | 2 |
| | Nickel trioxide | | 3 | 2 | 2 | 1 | |
| Preparation process | High temperature | 600 | 520 | 720 | 720 | 520 | 600 |
| | reaction temperature | | | | | | |
| | (° C.) | | | | | | |
| | High temperature | 15 | 10 | 20 | 13 | 17 | 15 |
| | reaction time | | | | | | |
| | (min) | | | | | | |
| | Voltage (kV) | 80 | 40 | 60 | 30 | 90 | 80 |
| | Current (uA) | 20 | 20 | 40 | 30 | 80 | 20 |
| | Air output (g/min) | 500 | 400 | 600 | 700 | 200 | 500 |
| | Spraying distance | 15 | 20 | 25 | 10 | 30 | 15 |
| | (cm) | | | | | | |
| | Sintering temperature | 530 | 530 | 530 | 600 | 550 | 530 |
| | (° C.) | | | | | | |
| | Sintering time | 15 | 10 | 20 | 13 | 17 | 15 |
| | (min) | | | | | | |
| | Sintering temperature | 7.5 | 5 | 10 | 12.5 | 15 | 7.5 |
| | increase rate (° C./min) | | | | | | |

| | | | | Compar- | Compar- | Compar- |
|---|---|---|---|---|---|---|
| | | | | ison | ison | ison |
| | | Embodi- | Embodi- | embodi- | embodi- | embodi- |
| | | ment 7 | ment 8 | ment 1 | ment 2 | ment 3 |
| | | Base metal | | | | |
| | | Aluminum or | Magnesium or | | | |
| | | aluminum | magnesium | Iron or | Iron or | Iron or |
| | | alloy | alloy | steel | steel | steel |
| Enamel powder | Total | 67 | 67 | 30 | 50 | 67 |
| Thermal expansion | Sodium silicate | 12 | 12 | | 5 | 12 |
| coefficient regulator | Potassium silicate | | | 10 | | |
| | Calcium silicate | | | 10 | | |
| | Sodium tetraborate | | | 10 | | |
| | Potassium tetraborate | 5 | 5 | 10 | | 5 |
| | Calcium borate | | | 10 | | |
| Flux | Sodium carbonate | 5 | 5 | 5 | 10 | 5 |
| | Potassium carbonate | | | 5 | | |
| | Magnesium carbonate | | | 5 | | |
| | Calcium fluoride | 5 | 5 | 5 | | 5 |
| | Potassium fluoride | | | | 10 | |
| | Magnesium fluoride | 1 | 1 | | 10 | 1 |
| Binder | Cobalt monoxide | 3 | 3 | | 5 | 3 |
| | Cobalt trioxide | | | | 5 | |
| | Nickel oxide | 2 | 2 | | | 2 |
| | Nickel trioxide | | | | 5 | |
| Preparation process | High temperature | 600 | 600 | 600 | 520 | 600 |
| | reaction temperature | | | | | |
| | (° C.) | | | | | |
| | High temperature | 15 | 15 | 15 | 10 | 10 |
| | reaction time | | | | | |
| | (min) | | | | | |
| | Voltage (kV) | 80 | 80 | 50 | 40 | 30 |
| | Current (uA) | 20 | 20 | 30 | 20 | 10 |
| | Air output (g/min) | 500 | 500 | 500 | 400 | 900 |
| | Spraying distance | 15 | 15 | 15 | 20 | 10 |
| | (cm) | | | | | |
| | Sintering temperature | 530 | 530 | 620 | 530 | 680 |
| | (° C.) | | | | | |
| | Sintering time | 15 | 15 | 15 | 10 | 15 |
| | (min) | | | | | |
| | Sintering temperature | 7.5 | 7.5 | 7.5 | 5 | 10 |
| | increase rate (° C./min) | | | | | |

TABLE 2
Composition ratio (mass ratio) of enamel powder in embodiments 1-8 and comparison embodiments 1-3.

| | | Embodi- | Embodi- | Embodi- | Embodi- | Embodi- | Embodi- |
|---|---|---|---|---|---|---|---|
| | | ment 1 | ment 2 | ment 3 | ment 4 | ment 5 | ment 6 |
| Silicon oxides | Silicon oxide | 30 | 15 | 15 | 10 | 9 | 30 |
| | Silicon dioxide | 5 | 4 | 20 | 10 | 15 | 5 |
| | Silicon peroxide | 4 | 3 | 4 | 19 | 15 | 4 |
| Sodium oxides | Sodium oxide | 20 | 4 | 4 | 10 | 15 | 20 |
| | Sodium peroxide | 4 | 20 | 4 | 10 | 3 | 4 |
| | Sodium hydroxide | 4 | 4 | 3 | 8 | 10 | 4 |
| Potassium oxides | Potassium oxide | 10 | 5 | 10 | 3 | 8 | 10 |
| | Potassium carbonate | 10 | 10 | 5 | 3 | 8 | 10 |
| | Potassium hydroxide | 5 | 10 | 10 | 2 | 9 | 5 |
| Phosphorus oxides | Phosphorus trioxide | 4 | 5 | 7 | 10 | 3 | 4 |
| | Phosphorus pentoxide | 3 | 5 | 3 | 0 | 5 | 3 |
| | Boron oxide | 1 | 15 | 10 | 15 | 0 | 1 |

| | | | | Compar- | Compar- | Compar- |
|---|---|---|---|---|---|---|
| | | | | ison | ison | ison |
| | | Embodi- | Embodi- | embodi- | embodi- | embodi- |
| | | ment 7 | ment 8 | ment 1 | ment2 | ment 3 |
| Silicon oxides | Silicon oxide | 30 | 30 | 40 | | 30 |
| | Silicon dioxide | 5 | 5 | | 30 | 5 |
| | Silicon peroxide | 4 | 4 | | | 4 |
| Sodium oxides | Sodium oxide | 20 | 20 | 10 | 5 | 20 |
| | Sodium peroxide | 4 | 4 | 10 | 15 | 4 |
| | Sodium hydroxide | 4 | 4 | 10 | | 4 |
| Potassium oxides | Potassium oxide | 10 | 10 | | | 10 |
| | Potassium carbonate | 10 | 10 | | 20 | 10 |
| | Potassium hydroxide | 5 | 5 | | | 5 |
| Phosphorus oxides | Phosphorus trioxide | 4 | 4 | 7 | 10 | 4 |
| | Phosphorus pentoxide | 3 | 3 | 8 | | 3 |
| | Boron oxide | 1 | 1 | 15 | 20 | 1 |

TABLE 3
Element content (mass ratio) of enamel coating in embodiments 1-8 and comparison embodiments 1-3.

| | | | | | | | | | Compar- | Compar- | Compar- |
|---|---|---|---|---|---|---|---|---|---|---|---|
| | | | | | | | | | ison | ison | ison |
| | Embodi- | Embodi- | Embodi- | Embodi- | Embodi- | Embodi- | Embodi- | Embodi- | embodi- | embodi- | embodi- |
| | ment 1 | ment 2 | ment 3 | ment 4 | ment 5 | ment 6 | ment 7 | ment 8 | ment 1 | ment 2 | ment 3 |
| Silicon | 7 | 3 | 30 | 4 | 15 | 7 | 7 | 7 | 1 | 50 | 8 |
| Sodium | 12 | 7 | 16 | 7 | 2 | 12 | 12 | 12 | 22 | 35 | 5 |
| Potassium | 7 | 15 | 10 | 10 | 3 | 7 | 7 | 7 | 17 | 2 | 3 |
| Calcium | 8 | 11 | 4 | 16 | 10 | 8 | 8 | 8 | 18 | 1 | 5 |
| Fluorine | 5 | 3 | 2 | 5 | 7 | 5 | 5 | 5 | 1 | 2 | 9 |
| Cobalt | 2 | 4 | 1 | 2 | 0.5 | 2 | 2 | 2 | 0 | 1 | 15 |
| Nickel | 2 | 4 | 0.5 | 2 | 8 | 2 | 2 | 2 | 0 | 1 | 15 |
| Boron | 5 | 8 | 2.5 | 2.5 | 10 | 5 | 5 | 5 | 14 | 1 | 1 |
| Phosphorus | 2 | 4 | 1 | 1.5 | 6 | 2 | 2 | 2 | 8 | 1 | 1 |
| Magnesium | 1 | 2 | 0.5 | 5 | 0.2 | 1 | 1 | 1 | 0 | 5 | 1 |
| Oxygen | 49 | 39 | 32.5 | 45 | 38.3 | 49 | 49 | 49 | 19 | 1 | 37 |

In order to verify the effect of the coating and coating method for anti-corrosion of steel bars of the present invention, the following tests were conducted.

1) Wear Resistance Test

According to the coating process of embodiment 1 and comparison embodiment 1, the coatings of the present invention were fabricated on steel plates, respectively, with two replicate samples per experimental group, and a total of four samples. The contents of silicon, sodium, potassium, calcium, fluorine, cobalt, nickel, boron, phosphorus, magnesium, and oxygen in comparative embodiment 1 are not within the scope of the claims. The wear resistance of the coating was tested according to the falling sand erosion test method of ASTM D968-93. The sand used was Chinese ISO standard sand. After the coating surface flushed out an area with a diameter of 2 mm, the sand falling was stopped and the volume of sand falling was recorded. When the falling sand volume is larger, the wear resistance of the coating is better.

TABLE 4
Wear resistance test data.

| | | | | Comparison | | |
|---|---|---|---|---|---|---|
| | Embodiment 1 | | | embodiment 1 | | |
| | Sample | Sample | Average | Sample | Sample | Average |
| | 1 | 2 | value | 3 | 4 | value |
| Falling | 12.6 | 12.4 | 12.5 | 4.0 | 4.2 | 4.1 |
| sand | | | | | | |
| volume | | | | | | |
| (L) | | | | | | |

From the volume of falling sand in Table 4, the average value of the falling sand volume of embodiment 1 of the present invention is 12.5 L, and the average value of the falling sand volume of comparison embodiment 1 is 4.1 L. It can be seen that the wear resistance of the coating of embodiment 1 is far superior to that of comparison embodiment 1.

2) Tensile Test

Six groups (Embodiments 1, 2, 3 and comparison embodiments 1, 2, 3) were selected with three replicate samples in each group, and three resistance strain gauges were attached to each coated steel bar. At the beginning of the experiment, the steel bar was placed on a tensile testing machine to measure the change of strain with load, and the resistance strain gauge was connected to a strain gauge to measure the strain change on the coated steel bar.

TABLE 5
Rebar tensile test.

| | | Coating cracking strain value (micro strain) | | | |
|---|---|---|---|---|---|
| | | Measuring | Measuring | Measuring | Average |
| | | point 1 | point 2 | point 3 | value |
| Embodi- | #1 tested | 2099 | 2100 | 2090 | 2096 |
| ment 1 | rebar | | | | |
| | #2 tested | 2050 | 2100 | 2076 | 2075 |
| | rebar | | | | |
| | #3 tested | 2071 | 2090 | 2046 | 2069 |
| | rebar | | | | |
| Embodi- | #1 tested | 1808 | 1888 | 1854 | 1850 |
| ment 2 | rebar | | | | |
| | #2 tested | 1789 | 1812 | 1822 | 1807 |
| | rebar | | | | |
| | #3 tested | 1866 | 1843 | 1823 | 1844 |
| | rebar | | | | |
| Embodi- | #1 tested | 1477 | 1423 | 1456 | 1452 |
| ment 3 | rebar | | | | |
| | #2 tested | 1508 | 1488 | 1478 | 1491 |
| | rebar | | | | |
| | #3 tested | 1400 | 1478 | 1492 | 1457 |
| | rebar | | | | |
| Compar- | #1 tested | 865 | 872 | 828 | 855 |
| ison | rebar | | | | |
| embodi- | #2 tested | 823 | 852 | 843 | 839 |
| ment 1 | rebar | | | | |
| | #3 tested | 847 | 821 | 853 | 840 |
| | rebar | | | | |
| Compar- | #1 tested | 789 | 777 | 761 | 776 |
| ison | rebar | | | | |
| embodi- | #2 tested | 750 | 756 | 781 | 762 |
| ment 2 | rebar | | | | |
| | #3 tested | 743 | 762 | 771 | 759 |
| | rebar | | | | |
| Compar- | #1 tested | 698 | 666 | 645 | 670 |
| ison | rebar | | | | |
| embodi- | #2 tested | 687 | 677 | 690 | 685 |
| ment 3 | rebar | | | | |
| | #3 tested | 669 | 650 | 666 | 662 |
| | rebar | | | | |

According to the experimental results in Table 5, when the coating was cracking, the average strain value of the three groups of coated steel bars of embodiment 1-3 was 1200-2300 micro strain, and the average strain value of the coated steel bars of comparison embodiments 1, 2, and 3 was in the range of 650-850 micro strain. Therefore, the steel rebar coated with the tough coating for reinforcing steel anticorrosion of the present invention can be coordinated with the building steel rebar. If the coating was fabricated not according to the specific material ratio and specific preparation process parameters, the performance of the coating could not meet the demand.

3) Rebar Corrosion Test

Six experimental groups and six control groups were selected, and the experimental group was coated steel bars (Embodiments 1, 4, 5 and comparison embodiments 1, 2, 3). The control group 1 was the coating data of the group 2 in the accelerated corrosion test of the steel bar in Table 1 of CN105670366B patent, and the control group 2 was the coating data of the group 1 in the accelerated corrosion test of the steel bar in the patent CN105819691A. The control group 3 was the data of coated round steel bar in the accelerated corrosion test of steel bar in Table 1 of CN105585883B patent. The control group 4 was the coating data of the group 3 in the accelerated corrosion test of steel bar in Table 4 of CN105238105B patent. The control group 5 was the data of the coating without fiber in the accelerated corrosion test of steel bar in Table 1 of CN105131660B patent. The control group 6 was uncoated bare steel. Place samples in a 3.5% sodium chloride solution and conduct an accelerated corrosion test after energizing.

TABLE 6
Accelerated corrosion test of steel bars.

Corrosion time (min)

| | # 1 | # 2 | # 3 | Average |
|---|---|---|---|---|
| Group | steel bar | steel bar | steel bar | value |
| Embodiment 1 | 1523 | 1521 | 1511 | 1518 |
| Embodiment 4 | 1576 | 1556 | 1566 | 1566 |
| Embodiment 5 | 1423 | 1511 | 1486 | 1473 |
| Comparison | 566 | 513 | 542 | 540 |
| embodiment 1 | | | | |
| Comparison | 500 | 540 | 532 | 524 |
| embodiment 2 | | | | |
| Comparison | 444 | 456 | 434 | 445 |
| embodiment 3 | | | | |
| Control group 1 | 1036 | 1045 | 1048 | 1043 |
| Control group 2 | 1176 | 1021 | 1078 | 1091 |
| Control group 3 | 673 | 778 | 798 | 750 |
| Control group 4 | 576 | 610 | 613 | 599 |
| Control group 5 | 273 | 349 | 336 | 319 |
| Control group 6 | 110 | 108 | 112 | 110 |

It can be seen from Table 6 that the uncorroded time of coated steel bars of embodiments 1, 4, and 5 is about 14 times longer than uncoated steel bars, 5 times of the corrosion resistance time of steel bar of CN105131660B, 2.5 times of the corrosion resistance time of steel bar of CN105238105B, 2 times of the corrosion resistance time of steel bar of CN105585883B, 1.5 times of the corrosion resistance time of steel bar of CN105670366B, 1.4 times of the corrosion resistance time of steel bar of CN105819691A. At the same time, it can be seen that the corrosion resistance of comparison embodiments 1, 2, and 3 is only one-third of that of embodiments 1, 4, and 5. Indicating that if the specific material ratio and specific preparation process parameters are not followed, the performance of the coating could not meet the demand.

4) Corrosion Resistance Test of Metal Plate

Take four experimental groups and a control group respectively, the experimental group was coated metal plate (Embodiments 1, 6, 7, 8), the control group was uncoated steel plate, uncoated copper plate, uncoated aluminum plate. The total number of test steel plates is 15. Place the samples in a 3.5% sodium chloride solution and conduct an accelerated corrosion test after energizing.

TABLE 7
Accelerated corrosion test of metal plates.

| | Group | | | |
|---|---|---|---|---|
| Corrosion | Embodi- | Embodi- | Embodi- | Embodi- |
| time (min) | ment 1 | ment 6 | ment 7 | ment 8 |
| Coated plate 1 | 1554 | 1557 | 1583 | 1565 |
| Coated plate 2 | 1501 | 1499 | 1511 | 1504 |
| Coated plate 3 | 1430 | 1467 | 1493 | 1463 |
| Average of | 1495 | 1508 | 1529 | 1511 |
| three plates | | | | |
| Uncoated | 107 | 113 | 112 | 111 |
| plates | | | | |

It can be seen form Table 7 that the uncorroded time of coated metal plates is around 14 times that of uncoated metal plates, it has an excellent corrosion resistance for steel plate, aluminum plate, magnesium plate, and copper plate.

5) Thermal Expansion Coefficient Test of Metal Plate

Take the embodiments 1-8 and comparison embodiments 1-3 for the thermal expansion coefficient test. The base metals of embodiments 1 to 5 and comparison embodiments 1, 2, and 3 are steel plates, the base metal of embodiment 6 is copper plate, the base metal of embodiment 7 is aluminum plate, and the base metal of embodiment 8 is magnesium plate. And for the steel plate, copper plate, aluminum plate and magnesium plate, three sets of plates with different thermal expansion coefficients were taken, and a total of 33 test pieces were tested for the coating thermal expansion coefficient. Among them, the enamel coating is C1, the base oxide coating is C2, and the enamel coating and the base oxide coating are collectively referred to as a double-layer structure coating, which is C1+C2. The thermal expansion coefficients of the enamel coating, the base oxide coating, and the double-layer structure coating were measured separately.

TABLE 8
Test for determination of thermal expansion coefficient of metal plates.

| | | Group | | | | | | | | | | |
|---|---|---|---|---|---|---|---|---|---|---|---|---|
| Thermal | | | | | | | | | | Compar- | Compar- | Compar- |
| expansion | | | | | | | | | | ison | ison | ison |
| coefficient | | Embodi- | Embodi- | Embodi- | Embodi- | Embodi- | Embodi- | Embodi- | Embodi- | embodi- | embodi- | embodi- |
| (×10⁻⁶/° C.) | | ment 1 | ment 2 | ment 3 | ment 4 | ment 5 | ment 6 | ment 7 | ment 8 | ments 1 | ments 2 | ments 3 |
| Coating | C1 | 12.8 | 13.0 | 13.1 | 13.0 | 13.1 | 17.3 | 24.5 | 26.5 | 12.1 | 12.0 | 12.4 |
| 1 | C2 | 12.6 | 12.7 | 12.6 | 12.5 | 12.8 | 17.0 | 24.0 | 26.2 | 12.0 | — | — |
| | C1 + | 12.7 | 12.8 | 12.8 | 12.7 | 12.9 | 17.2 | 24.2 | 26.3 | 12.1 | — | — |
| | C2 | | | | | | | | | | | |
| Base | | 12.5 | 12.5 | 12.5 | 12.5 | 12.5 | 16.8 | 23.9 | 26.1 | 12.5 | 12.5 | 12.5 |
| metal 1 | | | | | | | | | | | | |
| Coating | C1 | 11.2 | 11.2 | 11.3 | 11.0 | 11.2 | 13.7 | 20.6 | 23.8 | 10.0 | 10.5 | 10.8 |
| 2 | C2 | 10.8 | 10.9 | 11.0 | 10.8 | 10.8 | 13.5 | 20.4 | 23.6 | 10.0 | — | — |
| | C1 + | 10.9 | 11.0 | 11.1 | 11.0 | 10.9 | 13.6 | 20.5 | 23.7 | 10.0 | — | — |
| | C2 | | | | | | | | | | | |
| Base | | 10.8 | 10.8 | 10.8 | 10.8 | 10.8 | 13.5 | 20.4 | 23.5 | 10.8 | 10.8 | 10.8 |
| metal 2 | | | | | | | | | | | | |
| Coating | C1 | 15.6 | 12.8 | 15.8 | 16.0 | 15.6 | 19.4 | 25.7 | 28.9 | 14.9 | 15.1 | 15.5 |
| 3 | C2 | 15.5 | 15.5 | 15.4 | 15.6 | 15.5 | 19.2 | 25.6 | 28.7 | 14.9 | — | — |
| | C1 + | 15.5 | 15.6 | 15.6 | 15.7 | 15.5 | 19.3 | 25.6 | 28.8 | 14.9 | — | — |
| | C2 | | | | | | | | | | | |
| Base | | 15.4 | 15.4 | 15.4 | 15.4 | 15.4 | 19.2 | 25.5 | 28.6 | 15.4 | 15.4 | 15.4 |
| metal 3 | | | | | | | | | | | | |

It can be obtained from Table 8 that the thermal expansion coefficient of the double-layer structure coating (C1+C2) in the present invention would change with the change of the base metal, so the whole double-layer structure coating and the base metal are coordinated, thus proving that this coating is universal and can be applied to various metals. Meanwhile, it is also observed that when the base metal is iron or steel, the thermal expansion coefficient of the double-layer structure coating ranges from 10×10⁻⁶/° C. to 16×10⁻⁶/° C.; when the base metal is copper or a copper alloy, the thermal expansion coefficient of the double-layer structure coating ranges from 13×10⁻⁶/° C. to 20×10⁻⁶/° C.; when the base metal is aluminum or aluminum alloy, the thermal expansion coefficient of the double-layer structure coating ranges from 20×10⁻⁶/° C. to 26×10⁻⁶/° C.; when the base metal is magnesium or a magnesium alloy, the thermal expansion coefficient of the double-layer structure coating ranges from 23×10⁻⁶/° C. to 29×10⁻⁶/° C. At the same time, it can be seen that the thermal expansion coefficients of the base metal, the base oxide coating (C2), and the enamel coating (C1) are gradually increased, therefore it can be found that the coating has a gradient of thermal expansion coefficient. At the same time, it can be seen that the thermal expansion coefficients of comparative embodiments 1, 2, and 3 are not satisfied with the harmonized requirements, and none of comparative embodiments 1, 2, and 3 have a base oxide coating. It shows that if the specific material ratio and specific preparation process parameters are not followed, the performance of the coating would not meet the demand.

As can be seen from Table 3 to Table 8, the compositions of the coating are silicon, sodium, potassium, calcium, fluorine, cobalt, nickel, boron, phosphorus, magnesium, and oxygen meet the specific composition ratio. Combined with specific preparation process parameters, the metal coating of the specific double-layer structure of the present invention can be obtained. In the two-layer structure coating, there is a base metal oxide with a reduced concentration gradient from the inner layer to the outer layer.

6) Optical and Scanning Electron Microscope Images of Coating

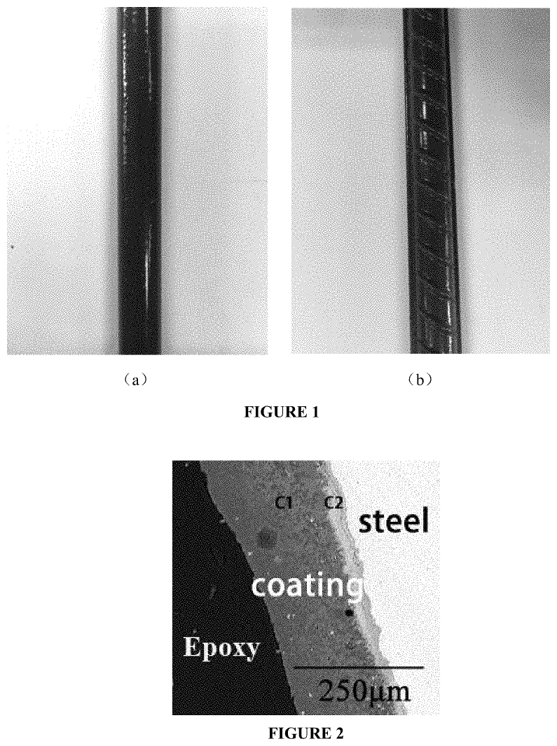

FIG. 1a is a picture of electrostatically sprayed round steel, using the raw material ratio of embodiment 1. It can be seen that the coating is very glossy from both macro and micro, the enamel gloss indicates that the coating has a higher density. There are no cracks in the coating due to too low thermal expansion coefficient, nor flaking due to excessive thermal expansion coefficient. It means that the thermal expansion coefficients of the coating and the base metal are in good agreement. This dense structure also means that the coating has a good corrosion resistance.

The detection method of the energy spectrometer (EDS) is: EDSmeasurement adopts the energy spectrometer to test. First, the surface of the sample is ground and polished, and the gold nanoparticles are sprayed on the surface to make a gold film which is conductive, and then the sample is attached to the conductive tape. The acceleration voltage value is adjusted to 10-40 kV, the dead time is 15-45%, and the measurement time is fixed to 50-400 s. The sample is put into the sample cavity, the parameters are set and the vacuum makes the focus clear, the area is selected that needs element analysis and the position is maintained, the point scan, area scan, line scan for element analysis are applied. Through the detection of EDS technology, it is obtained that the silicon content is 7%, the sodium content is 12%, the potassium content is 7%, the calcium content is 8%, the fluorine content is 5%, the cobalt content is 2%, the nickel content is 2%, the boron content is 5%, the phosphorus content is 2%, the magnesium content is 1%, and the oxygen content is 49%.

FIG. 1b is a picture of electrostatically sprayed rebar, using the raw material ratio of embodiment 1. It can also be seen that the coating has a dense structure and an enamel gloss. It can be seen that no cracking occurs at the boundary between the convex surface and the plane, indicating that the coating does not crack during the high-temperature sintering process. Furthermore, it illustrates that the thermal expansion coefficient gradient double-layer coating of the present invention can deform collaboratively with the base metal at high temperatures.

FIG. 2 is an electron micrograph of embodiment 1, which is similar to embodiments 2 and 3, so embodiment 1 is taken as a representative. It can be seen that the thickness of the coating is about 200 μm, the density is very high. There are no through holes, only a small number of closed pores. The area of closed pores is calculated to obtain a closed pore rate of 4.3%. The presence of a small number of closed pores can make the coating have a certain ductility. At the same time, the coating consists of two parts, namely enamel coating (C1) and base oxide coating (C2). The thickness of C1 is about 180 μm and the thickness of C2 is about 20 μm. C1, C2 and the steel bar form a sandwich structure. Because of sintering in an oxidizing atmosphere, C2 are formed. Besides iron oxide, Fe—Co and Fe-Ni mixed crystals also exist in C2, which makes the coating more tightly bonded to the steel bar. And the thickness of C2 is controllable, and its thickness would increase with the increase of sintering temperature. At the same time, due to the presence of the outer coating C1, it would inhibit the contact between the external oxygen and the C2 layer, so the thickness of the coating is controlled to around 20 μm. In addition, the presence of the C2 transition layer in the coating can not only increase the adhesion, but also effectively improve the corrosion resistance.

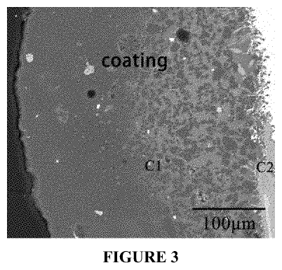

FIG. 3 is a partially enlarged electron micrographfrom FIG. 2. In FIG. 3, it can be clearly seen that the coating near the steel bar is significantly different from the coating away from the steel bar. The area of white spots in the coating nearer to the steel bar is getting larger and larger. The EDS results show that the white spots are iron oxide components. The iron element of the whole coating (C1+C2) gradient changes from more to less from inside to outside, therefore iron oxide also gradient changes from more to less from inside to outside. This change also causes a gradient change in the thermal expansion coefficient of the coating. As the iron oxide decreases, the thermal expansion coefficient of the coating gradually increases. The double-layered thermal expansion coefficient gradient structure of this sandwich structure makes the coating and the steel bar has an extremely strong adhesion and 14 times better corrosion resistance than ordinary bare steel.

What is claimed is:

1. A metal anticorrosive coating, characterized by:
the metal anticorrosion coating is a double-layer structure coating, which is composed of an enamel coating and a base oxide coating;
in the double-layer structure, the enamel coating is the outer layer, the base oxide coating is the inner layer, and the inner layer is in contact with the base metal. The composition of the enamel coating includes, by weight, 1-40 parts of silicon, 1-30 parts of sodium, 1-20 parts of potassium, 2-20 parts of calcium, 0.5-15 parts of fluorine, 0.3-10 parts of cobalt, and 0.2-10 parts of nickel, 1-18 parts of boron, 0.5-10 parts of phosphorus, 0.1-8 parts magnesium, the rest is oxygen. The composition of the base oxide coating includes base metal element and oxygen;
in the two-layer structure coating, there is a base metal oxide with a reduced concentration gradient from the inner layer to the outer layer.

2. The metal anticorrosive coating of claim 1, wherein the thermal expansion coefficient of the double-layer structure coating is coordinate with the thermal expansion coefficient of the base metal.

3. (canceled)

4. The metal anticorrosive coating of claim 1, wherein the content of the base metal in the base oxide coating is 40 to 85 parts, and the rest is oxygen.

5. The metal anticorrosive coating of claim 1, wherein the composition of the enamel coating includes 2-30 parts of silicon, 2-20 parts of sodium, 2-15 parts of potassium, 4-16 parts of calcium, 2-10 parts of fluorine, 0.5-7 parts of cobalt, 0.3-8 parts of nickel, 2-10 parts of boron, 0.8-6 parts of phosphorus, 0.2-5 parts of magnesium, the rest is oxygen.

6. The metal anticorrosive coating of claim 1, wherein the base metal is selected from iron, steel, copper, copper alloy, aluminum, aluminum alloy, magnesium, and magnesium alloy.

7. The metal anticorrosive coating of claim 1, wherein the silicon, sodium, potassium, calcium, fluorine, cobalt, nickel, boron, phosphorus, magnesium, and oxygen elements are determined by energy dispersive spectrometer (EDS), the specific method is as follows: the EDS test is operated on an energy spectrometer; firstly, the surface of the sample is ground and polished, and the gold nanoparticles are sprayed on the surface to make a gold film which is conductive, and then the sample is attached to the conductive tape; secondly, the acceleration voltage value is adjusted to 10-40 kV, the dead time is 15-45%, and the measurement time is fixed to 50-400 s; thirdly, the sample is put into the sample cavity, the parameters are set and the vacuum makes the focus clear, the area is selected that needs element analysis and the position is maintained, the point scan, area scan, line scan for element analysis are applied.

8. The metal anticorrosive coating of claim 1, wherein the enamel coating component is selected from enamel powder, thermal expansion regulator, flux, and binder. The content of the enamel powder is 40-90 parts, the content of the thermal expansion regulator is 5-40 parts, the content of the flux is 1-20 parts, the content of the binder is 0.5-12 parts, the content is based on weight.

9. The metal anticorrosive coating of claim 8, wherein the element content of the enamel powder is: 1-40 parts of silicon, 1-20 parts of sodium, 1-23 parts of potassium, 1-18 parts of calcium, 0-10 parts of boron, 0.8-10 parts of phosphorus.

10. The metal anticorrosive coating of claim 8, in the enamel powder, content of siliconoxides is 3-39 parts, content of sodium oxides is 3-28 parts, content of potassium oxides is 1-25 parts, content of boron oxide is 0-15 parts, content of phosphorus oxides is 0.5-10 parts, the content is based on weight.

11. The metal anticorrosive coating of claim 10, wherein the silicon oxides are selected from one or more of silicon oxide, silicon dioxide, and silicon peroxide.

12. The metal anticorrosive coating of claim 10, wherein the sodium oxides are selected from one or more of sodium oxide, sodium peroxide, and sodium hydroxide.

13. The metal anticorrosive coating of claim 10, wherein the potassium oxides are selected from one or more of potassium oxide, potassium carbonate, and potassium hydroxide.

14. The metal anticorrosive coating of claim 10, wherein the phosphorus oxides are selected from one or more of phosphorus trioxide and phosphorus pentoxide.

15. The metal anticorrosive coating of claim 8, wherein the thermal expansion regulators are selected from one or more of sodium silicate, potassium silicate, calcium silicate, magnesium silicate, sodium tetraborate, potassium tetraborate, calcium borate, barium borate, and lithium borate.

16. The metal anticorrosive coating of claim 8, wherein the fluxs are selected from one or more of sodium carbonate, potassium carbonate, magnesium carbonate, strontium carbonate, lithium carbonate, calcium carbonate, barium carbonate, calcium fluoride, magnesium fluoride, and potassium fluoride.

17. The metal anticorrosive coating of claim 8, wherein the binders are selected from one or more of cobalt monoxide, cobalt trioxide, nickel monoxide, and nickel trioxide.

18-21. (canceled)

22. A method for preparing a metal anticorrosive coating and a metal product with a metal anticorrosive coating, characterized in that it includes the following steps:
1) the first grinding: weight the enamel powder, thermal expansion regulator, flux, and binder; and the content of the enamel powder is 40-90 parts, the content of the thermal expansion regulator is 5-40 parts, the content of flux is 1-20 parts, the content of binder is 0.5 to 12 parts; the content is based on weight, and ground into powder;
2) preparation of the mixture: mixing the above four raw materials with water to obtain a mixture;
3) the second grinding: grind the mixture obtained in step 2) into powder after drying;
4) high-temperature reaction: the mixture obtained in step 3) is reacted in a high-temperature furnace at 520 to 720° C. for 10 to 20 minutes;
5) the third grinding: grind the mixture after high temperature reaction to obtain coating powder;
6) coating: coating the powder obtained in step 5) on the base metal;
7) sintering: the powder-coated base metal obtained in step 6) is sintered at high temperature to obtain a metal anticorrosive coating and a metal product with a metal anticorrosive coating; the metal anticorrosive coating is a double-layer structure coating, which is composed of an enamel coating and a base oxide coating. In the double-layer structure, the enamel coating is an outer layer, and the base oxide coating is an inner layer; the inner layer is in contact with the base metal; the composition of the base oxide coating includes the base metal and oxygen; the double-layer structure coating, there is a base metal oxide with a reduced concentration gradient from the inner layer to the outer layer;
the composition of the enamel coating includes, by weight, 1-40 parts of silicon, 1-30 parts of sodium, 1-20 parts of potassium, 2-20 parts of calcium, 0.5-15 parts of fluorine, 0.3-10 parts of cobalt, and 0.2-10 parts of nickel, 1-18 parts of boron, 0.5-10 parts of phosphorus, 0.1-8 parts of magnesium, and the rest is oxygen. The composition of the base oxide coating includes base metal and oxygen.

23. (canceled)

24. The preparation method according to claim 18, wherein the sintering parameters of step 7) are: a temperature of 500-620° C., a sintering time of 10-20 minutes, and a temperature increase rate of 5-15° C. per minute.

25-37. (canceled)

38. A metal product, characterized in that the metal product comprises the metal anticorrosive coating according to any one of claim 1.

39-40. (canceled)

41. The metal anticorrosive coating of claim 1, wherein when the base metal is iron or steel, the thermal expansion coefficient of the double-layer structure coating is 10×10⁻⁶/° C.˜16×10⁻⁶/° C. when the base metal is copper or copper alloy, the thermal expansion coefficient of the double-layer structure coating is 13×10⁻⁶/° C.˜16×10⁻⁶/° C. when the base metal is aluminum or aluminum alloy, the thermal expansion coefficient of the double-layer structure coating is 20×10⁻⁶/° C.˜26×10⁻⁶/° C., when the base metal is magnesium or magnesium alloy, the thermal expansion coefficient of the double-layer structure coating is 23×10⁻⁶/° C.˜29×10⁻⁶/° C.
